(19) United States
(12) Patent Application Publication
(10) Pub. No.: US 2007/0092605 A1
(43) Pub. Date: Apr. 26, 2007

(54) Process by which the sensory properties of a fermented dairy product are modified, and maturation thereof during the conservation of said product

(76) Inventors: Remy Cachon, Dijon (FR); Gilles Feron, Pontailler Sur Saone (FR); Carole Delbeau, Dijon (FR); Dominique Ibarra, Gif Sur Yvette (FR); Henry Ledon, Versailles (FR)

Correspondence Address: AIR LIQUIDE, 2700 POST OAK BOULEVARD, SUITE 1800, HOUSTON, TX, 77056, US

(21) Appl. No.: 11/255,462

(22) Filed: Oct. 21, 2005

(51) Int. Cl. A23C 9/12

(52) U.S. Cl. 426/40

(57) ABSTRACT

Processes for producing dairy products. A fermented dairy product, of the type where, during one of the steps of the production process, a milk mixture is seeded with one or more strains of lactic acid bacteria. Before the seeding step, the milk mixture is treated with a treatment gas containing hydrogen, so as to obtain a desired redox potential value Eh of the milk mixture that is less than the value obtained when the milk mixture is in equilibrium with air.

### BACKGROUND

The present invention relates to the field of the production of fermented dairy products; it has endeavored to propose a novel process for producing products for which the fermentation conditions are controlled and which exhibit novel sensory properties.

The invention deals with dairy products of “yogurt” or “fermented milk” type, with unripened cheeses, the production of which comprises a fermentation step, of the type soft white cheese, fromage frais such as slightly salted or “petit-suisses”, with cottage cheese, etc, not forgetting matured creams, sour butters, whether they are produced from milk or from substances of dairy origin from any source, and in particular cow, ewe, goat, mare, etc. It will therefore have been understood from reading the above that the invention does not relate to “ripened” cheeses.

It should briefly be recalled here that ripening represents the final step in the production of a cheese; ripening is a more or less long maturation step under defined conditions of atmospheric temperature and humidity during which biochemical and enzymatic reactions take place along with the development of the surface flora.

“Unripened” cheeses are therefore cheeses that have not undergone any ripening step.

It is known that, according to the most commonly accepted definition, the name “fermented milk” is, for example, intended to mean a milk product prepared with skimmed or unskimmed milks, or skimmed or unskimmed milk concentrates or powdered milks, that may or may not be enriched with milk constituents, having undergone a heat treatment at least equal to pasteurization, seeded with microorganisms belonging to the one or more species characteristic of each product.

Similarly, the name “yogurt” is intended to mean a fermented milk obtained, according to trusted and constant practices, through the development of only specific thermophilic lactic acid bacteria called Lactobacillus bulgaricus and Streptococcus thermophilus, which must be seeded simultaneously and be alive in the finished product, in a proportion of at least 10 million bacteria per gram relative to the milk portion.

Oxidoreductions are essential steps in the reactions of cellular anabolism and catabolism, for which the direction of the exchanges is determined by the redox potential (hereinafter Eh). The Eh is a parameter of fermentation state: variation thereof modifies the physicochemical environment of microorganisms. The metabolic activities and the physiology of microorganisms are determined by the intracellular pH (pHᵢₙ), which will condition the activity of the enzymes and the accessibility of certain substrates and cofactors in the metabolic reactions. The pHᵢₙ depends on the extracellular pH (pHₑₓ) and on the ability of the microorganism to maintain a certain cellular homeostasis. The difference between the pHᵢₙ and the pHₑₓ will also modify the value of the proton motive force ΔμH⁺, {ΔμH⁺=ΔΨ (gradient of electrical potential)−ZΔpH (pH gradient)}, which is in particular involved in the microbial cell's exchanges with the outside. The Eh and pHᵢₙ parameters are closely linked; thus, the energy found in compounds with a high potential, such as adenosine triphosphate (ATP), and obtained by substrate catabolism may be used by the cell in order to maintain its pHᵢₙ (and therefore its ΔpH) by virtue of membrane ATPases.

According to Urbach et al in 1995 (“Contribution of lactic acid bacteria to flavor compound formation in dairy products”, International Dairy Journal. 5: 877-903), lactic bacteria are widely involved in the production of the flavors of fermented dairy products; they convert lactose to lactic acid; this results in the production of diacetyl and of acetaldehyde, which are the main flavors of fermented milks and of fromage frais. The Eh is an environmental parameter which will be able to condition the metabolic activities of the microorganisms and in particular their ability to synthesize flavoring molecules. In particular, it has been shown, for emmental and cheddar, that good quality cheeses have a low redox potential.

For yogurts, many volatile compounds are involved in the flavor thereof: hydrocarbons, alcohols, aldehydes, ketones, acids, esters, lactones, sulphur compounds and furans (article by Ott et al., published in 1997 in Journal of Agricultural and Food Chemistry. 45(3): 850-858).

The Eh is a physicochemical parameter which, by virtue of its nature, acts on all media provided that the latter contain at least one molecule that can pass from an oxidized state to a reduced state, and vice versa. This is why it has a perceptible effect on all cell functions. Its action has been shown on various types of bacterial strains:

The addition of chemical reducing agents to culture media has made it possible to significantly modify the growth and the metabolic fluxes in Corynebacterium glutamicum, Clostridium acetobutylicum, Sporidiobolus ruinenii and Escherichia coli (see, for example, the studies by Kwong et al., published in 1992 in Biotechnology and Bioengineering. 40: 851-857).

A reducing Eh fixed by gases has made it possible to modify metabolic fluxes in Saccharomyces cerevisiae, with an increase in the glycerol/ethanol ratio and the accumulation of storage sugars, with an increase in survival of the yeast during conservation (see document FR 2,811,331 in the applicant's name).

In the industrial environment, the Eh is already indirectly taken into account through oxygen, the inhibitory effect of which on lactic acid bacteria has been clearly identified. This effect is due to their inability to synthesize cytochromes and enzymes containing a haem nucleus.

It is known, moreover, that it is also possible, by acting on the Eh, to modify the survival of probiotic ferments, metabolic fluxes, and the production and/or stability of flavoring molecules. All these results were obtained subsequent to a modification of the Eh by the microorganisms themselves, by means of oxido-reductive molecules, or by thermal treatment.

It is seen that, in the perspective of a food, pharmaceutical or veterinary application, the variation in Eh must involve compounds that do not modify the characteristics of the product. For this reason, studies of the prior art proposed the use of pure gases or mixtures of gases that will preserve the innocuousness of the products (in this respect, reference may be made to document FR 2.811.331 in the applicant's name, already mentioned above, and also to the article by Vonktaveesuk Phenjun et al., published in 1994 in Journal of Fermentation and Bioengineering. 77 No. 5: 508-512).

In the field of the use of mixtures of gases in lactic acid bacteria fermentation media, mention may finally be made of the studies by Henriksen et al., published in Letters in Applied Microbiology in 2000 (vol. 30 p. 415-418), which focused on the growth of lactic acid bacteria and showed that, when the cultures were swept with nitrogen, growth was greatly slowed down, whereas the addition of tiny amounts of CO₂ in this case caused growth to recommence exponentially.

### SUMMARY

The present invention relates to a process for producing a fermented dairy product having improved organoleptic properties, of the type in which, during one of the steps of the production process, a milk mixture is seeded with one or more strains of lactic acid bacteria, and characterized in that, before the seeding step, the milk mixture is treated with a treatment gas containing hydrogen so as to obtain a desired redox potential value Eh of the milk mixture that is less than the value obtained when the milk mixture is in equilibrium with air.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates the evolution of the composition of the head space for various conditions;

FIG. 2 illustrates the order of preference of the yogurts according to the gas treatments;

FIG. 3 illustrates yogurts most liked at various conditions;

FIG. 4 illustrates yogurts least liked at various conditions;

FIG. 5 illustrates the evolution of syneresis according to the conditioning of the milk;

FIG. 6 illustrates the evolution of the concentration of acetaldehyde according to the conditioning of the milk;

FIG. 7 illustrates the evolution of the amount of demithyl sulfide according to the conditioning of the milk;

FIG. 8 illustrates the evolution of the amount of diacetyl according to the conditioning of the milk; and

FIG. 9 illustrates the evolution of the amount of 2,3-pentanedione according to the conditioning of the milk.

### DETAILED EMBODIMENTS

One of the objectives of the present invention is to propose novel conditions for improving the organoleptic characteristics of a fermented dairy product of the type of those listed above.

It will be recalled, for example, that the production of a yogurt commonly comprises the following steps:

preparation of the milk, which generally comprises the addition of components such as fats or proteins so as to fix the composition thereof;

a pasteurization step (heat treatment);

homogenization (which can take place before or after pasteurization);

cooling to the temperature at which the fermentation will take place;

seeding with the desired strains;

according to the type of yogurt: tank fermentation followed by smoothing before placement in pots (“stirred” yogurts), or else prior dispensing into pots in which the fermentation will take place (“solid” yogurts).

As will be seen below in greater detail, the process for preparing a fermented dairy product according to the invention is notable in that the milk mixture considered (whole milk, partially skimmed or skimmed milk, milk with a standardized fat content, milk with a standardized protein content, milk fortified with powdered skimmed milk or milk concentrate, cream, buttermilk, etc) is treated with a gas containing hydrogen, so as to obtain a desired redox potential value Eh that is less than the value obtained when the mixture is in equilibrium with air, before the seeding step.

In addition, as will also be seen in detail below, the products thus produced have substantially improved organoleptic properties.

It should be noted that the seeding of the production tanks can be carried out directly, or indirectly, i.e. one or more successive precultures are then performed in order to constitute the inoculum which will serve to seed the milk mixture to be fermented.

According to the invention, if the seeding is carried out indirectly, it is not only possible to treat the milk mixture before seeding, as explained above, but also more advantageously to produce the preculture by treating its growth medium with a treatment gas, making it possible to obtain a redox potential value that is less than the value obtained in the absence of treatment.

It is therefore understood that, according to the invention, by using a stream of gas that reduces, compared with air, the redox potential of the medium treated is decreased compared with the value that it would have in the absence of said stream of gas, i.e. in air, all things being otherwise equal.

The invention thus covers the reducing media per se (the redox potential has been decreased below 0), but also the case where the stream of gas makes it possible to decrease the redox potential of a medium that is initially oxidizing, even if the final potential achieved using said stream of gas remains positive in itself (the medium is then, at the end, still an oxidizing medium).

It is recalled that the redox potential values depend in particular on the composition of the culture medium and on its pH, the reference used for assessing the decrease in redox potential obtained in accordance with the invention having the same medium composition at a similar pH.

The gas-liquid contact can be obtained according to one of the methods well known to those skilled in the art, such as bubbling through the milk mixture using a sintered glass funnel, a membrane or a porous substance, agitation by means of a hollow-shafted turbine, use of a hydro-injector, etc. One or more gas injection points can be used in the reception and storage tanks for the milk, standardization tanks, enriching tanks, inoculation tanks, etc.

On-line injections can also be carried out on various parts of pipework of the production plants leading from one station to the other of this plant.

The redox potential value can be measured either after the first gas injection point, or at several points, and preferably in the inoculation tank, or in the fermentation tank. It is particularly advantageous for the redox potential to be decreased to the desired value or close to the desired value before the heat treatment, in order to limit the impact of the development of a burnt taste during said treatment.

The present invention therefore relates to a process for producing a fermented dairy product having improved organoleptic properties, of the type in which, during one of the steps of the production process, a milk mixture is seeded with one or more strains of lactic acid bacteria, and characterized in that, before the seeding step, the milk mixture is treated with a treatment gas containing hydrogen so as to obtain a desired redox potential value Eh of the milk mixture that is less than the value obtained when the milk mixture is in equilibrium with air.

The process according to the invention can also adopt one or more of the following technical characteristics:

said desired redox potential value is less than +250 mV;

said desired redox potential value is at least 100 mV less than the value obtained when the milk mixture is in equilibrium with air;

said desired redox potential value is negative;

the sensory properties of the dairy product thus produced are modified;

the amounts of flavoring compounds produced are modified in the dairy product thus produced;

the syneresis of the dairy product thus produced is modified;

the seeding of the milk mixture is carried out indirectly due to the fact that one or more successive precultures are performed beforehand in order to constitute the inoculum which will serve to seed the milk mixture to be fermented, and the preculture is also treated by treating its growth medium with a pretreatment gas making it possible to obtain a redox potential value that is less than the value that would be obtained in the absence of treatment;

said treatment or pretreatment gas is hydrogen;

said pretreatment gas is nitrogen;

said treatment or pretreatment gas is a mixture of hydrogen and nitrogen;

said treatment or pretreatment gas also comprises an additional gas that is acceptable from the point of view of said dairy product under consideration;

the additional gas is chosen from inert gases, in particular argon and helium, and from oxygen, carbon dioxide and nitrous oxide, and mixtures thereof in any proportions, preferably from carbon dioxide and oxygen, and also mixtures thereof;

said treatment or pretreatment gas is a mixture of hydrogen and carbon dioxide.

Other characteristics and advantages of the invention will emerge from the detailed examples below.

### EXAMPLES

### Example 1

Sensory Properties of Yogurts Prepared at Various Redox Potential Values

Sterile skimmed milk was treated for 40 minutes at a flow rate of 0.15 vvm (volume of gas per volume of medium per minute) in 250 ml Schott flasks, by bubbling in three different gases, until a constant (stabilized) value for the redox potential Eh was obtained:

1. Air (reference);

2. Nitrogen; and

3. Mixture of nitrogen/hydrogen 96/4 by volume.

The redox potential values thus achieved, related back to pH 7 (by formulae well known to those skilled in the art such as the Leistner and Mirna equation which makes it possible to relate the Eh of a medium of pH=x back to its value at pH 7) according to the gas used, measured with a Mettler Toledo probe, are as follows:

| | | Nitrogen/hydrogen |
|---|---|---|
| Air | Nitrogen | (96/4) |
| +326 mV | +211 mV | −319 mV |

The media were then seeded with a mixture of lactic acid bacteria: Streptococcus thermophilus and Lactobacillus bulgaricus, and then placed in a water bath at 42° C. until a pH of 4.6 was reached; at this pH, the fermenters were placed in a water bath at 4° C. for 1 hour in order to stop the acidification. The yogurts thus produced were placed in a cold room at 4° C.

a) Control of the Gas Atmosphere

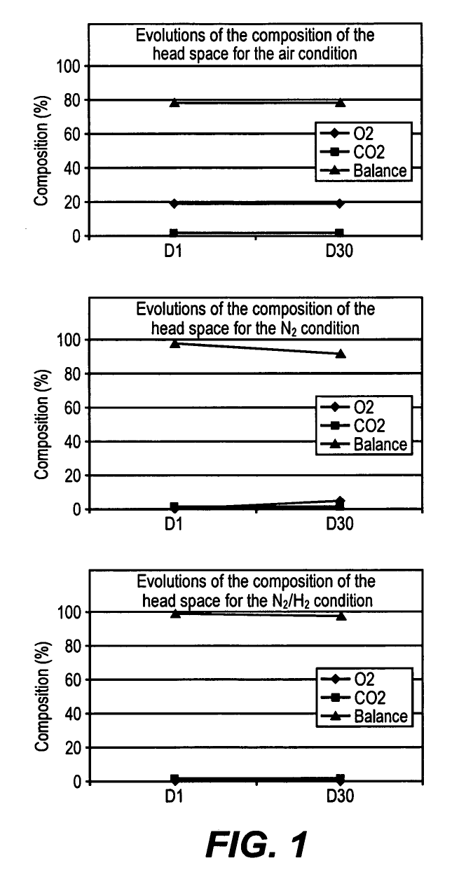

The gas composition of the head space of the fermenters was determined using a gas analyzer (Dynatest). The results given in FIG. 1 show that the gas composition in the head space is stable at 30 days.

b) Sensory Analysis of Yogurts

The sensory analysis was carried out by a jury consisting of 13 individuals who were untrained in terms of yogurt tasting and were recruited from the doctoral students and the permanent staff of a microbiology laboratory. The samples were coded and presented randomly to the panel at 1 to 30 days of storage (legal shelf life of the product). Olfactory and gustative marks ranging from 0 to 10 were given for each sample; the order of preference of the yogurts was also determined.

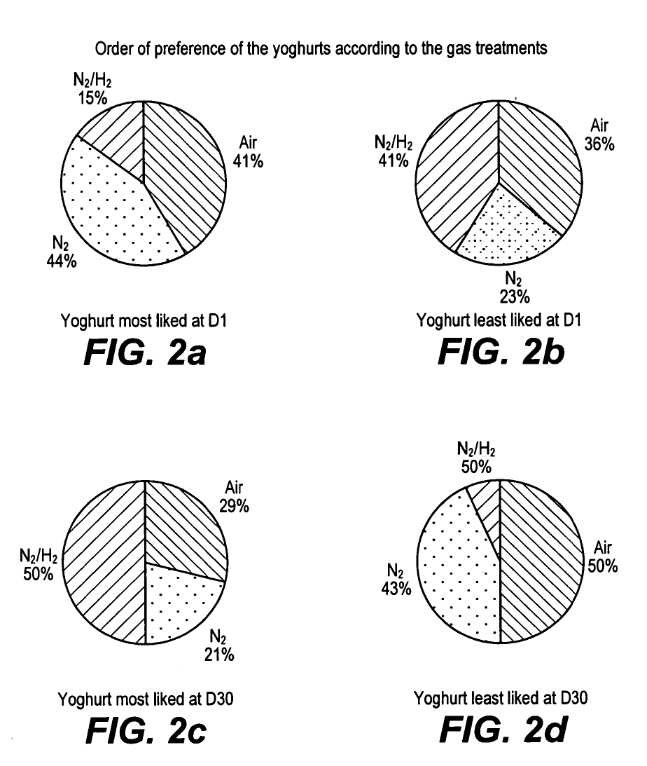

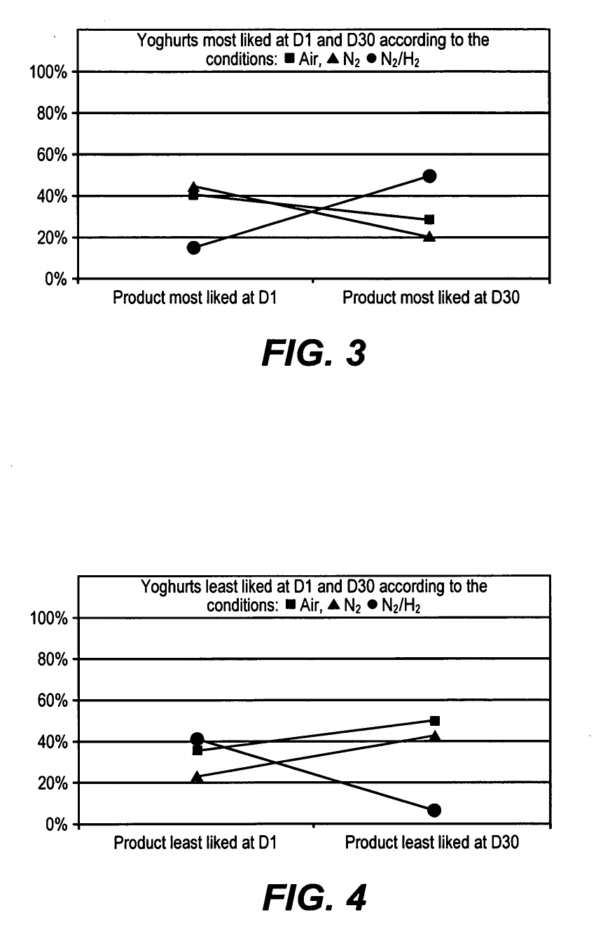

The orders of preference observed are illustrated below in FIGS. 2, 3 and 4.

It appears that, at D1, the yogurts conditioned under air and under nitrogen are the most liked. A reversal of this tendency is observed at D30, since the yogurts conditioned under nitrogen/hydrogen are those that are preferred.

### Example 2

Effect of the Reducing Conditions on the Exudation and the Aromatic Compounds of a Yogurt

The conditions of Example 1 were reproduced, but this time by dispensing the seeded milks into 25 ml Schott flasks (conditioning under corresponding atmosphere) before the fermentation in a water bath.

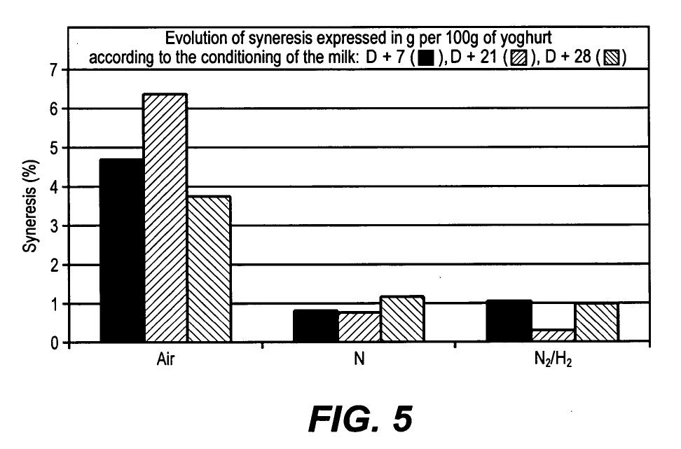

During the lifetime of the yogurt, the change in exudation was followed at D+7, D+21 and D+28. FIG. 5 represents the results at D7, D21 and D28. They show a significant effect of the treatment carried out according to the invention, on exudation. Production of yogurts under reducing conditions (N₂ or N₂/H₂) therefore makes it possible to very significantly reduce the exudation phenomenon compared with production under air.

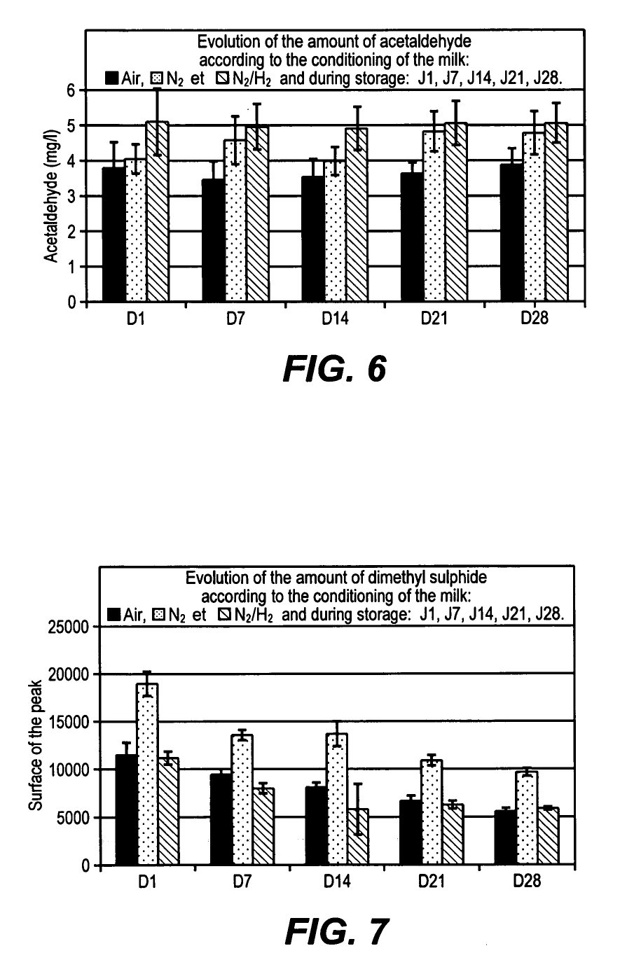

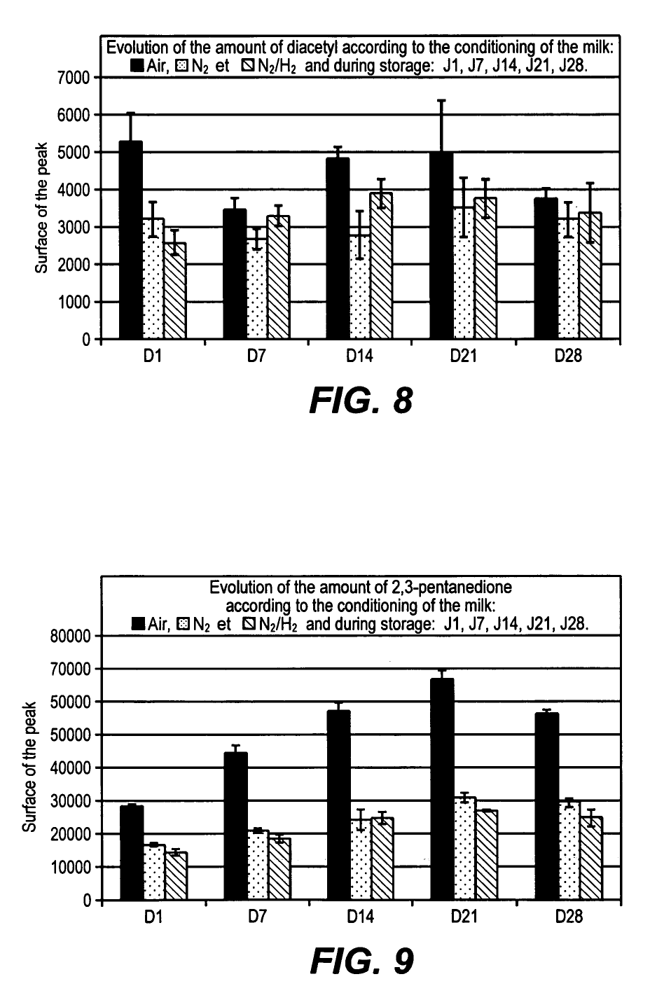

Moreover, the contents of 4 flavoring compounds characteristic of yogurt were also determined: acetaldehyde, dimethyl sulfide, diacetyl and 2,3-pentanedione. The results are given in FIGS. 6 to 9.

Statistical treatment of the results shows, first of all, a greater amount of acetaldehyde for the yogurts produced from the milk conditioned under N₂/H₂ compared with that obtained for the milk conditioned under N₂, itself greater than that obtained under air.

Moreover, a decrease in the amount of dimethyl sulfide in the course of the first 3 weeks of storage is demonstrated for the 3 conditions. It should be noted that the amount of the compound is each time slightly greater in the yogurts produced with milk conditioned under nitrogen compared with air and with the N₂/H₂ mixture.

The amount of diacetyl in the yogurts remains relatively stable during storage. A slightly greater amount of this compound appears to be demonstrated under air, compared with the less oxidizing conditions, in the first 3 weeks of storage, but it is equivalent at D28.

The amount of 2,3-pentanedione increases during the storage up to D21. It is significantly greater under air compared with the N₂ condition, which is itself greater than the N₂/H₂ condition, over the 4 weeks.

In conclusion, it may be emphasized that the results of these trials indicate that certain yogurts were found to be more pleasing than others. This clearly shows that sensory differences exist between the products produced according to the various atmospheres tested in terms of their intervention before seeding.

These organoleptic differences are explained, in particular from an olfactory and gustative point of view, by the significant effect, as was demonstrated above, of the Eh on the amount of various flavoring compounds in the finished product.

Similarly, it was shown that a decrease in the Eh makes it possible to reduce the exudation phenomenon that has a negative image in the eyes of the consumer. This decrease in syneresis reflects better stability of the yogurt. It may be due to a greater production of bacterial exopolysaccharides and/or to a modification of the biochemical reactions that produce the protein network.

A reducing environment therefore has an impact on the orientation of metabolic fluxes of bacteria, as it does on the biochemical reactions that occur during the production of dairy products such as yogurts and fermented milks.

Thus, in terms of texture, the milk naturally contains serum proteins. During the production of dairy products such as yogurts or fermented milks, it is often enriched with milk ingredients that themselves contain lactoserum proteins (β-lactoglobulin and α-lactalbumin). Now, these proteins are rich in sulphur-containing amino acids. The latter are involved during the formation of the protein network of the yogurt, in particular via disulfide bridges. It may be considered that the addition of a reducing gas (or reducing gas mixture) will influence the oxidoreduction reactions involving the RSH/RS—SR pairing. The protein network of such dairy products may find itself modified by this, as may, consequently, the rheological properties of the product and therefore the perceived texture in the pot or in the mouth.

Furthermore, mention should be made of another advantage of the invention, related to the fact that, since the invention makes it possible to make the medium a reducing medium, it may be considered that this would make it possible to protect certain compounds (whether they are naturally present or added to the formulation) that are particularly sensitive to oxidation, such as fats, certain vitamins, etc.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-14. (canceled)

15. A method which may be used for producing a fermented dairy product with improved organoleptic properties, said method comprising:
a) treating a milk mixture with a treatment gas comprising hydrogen, wherein said treated mixture has a desired redox potential value less than the redox potential value when said milk mixture is in equilibrium with air; and
b) seeding said milk mixture with at least one strain of lactic acid bacteria.

16. The method of claim 15, wherein said desired redox value is less than about +250 mV.

17. The method of claim 16, wherein said desired redox value is at least about 100 mV less than said equilibrium redox value.

18. The method of claim 16, wherein said desired redox value is negative.

19. The method of claim 15, wherein the sensory properties of a diary product produced are modified.

20. The method of claim 15, wherein the amounts of flavoring compounds produced in a dairy product are modified.

21. The method of claim 15, wherein the syneresis of a dairy product are modified.

22. The method of claim 15, further comprising:
a) seeding said milk mixture indirectly, wherein at least one successive preculture is performed previously so as to constitute an inoculum which will serve to seed said milk mixture to be fermented; and
b) treating the growth medium of said preculture with a pretreatment gas wherein said treating reduces the redox potential value of said preculture.

23. The method of claim 22, wherein said pretreatment gas comprises hydrogen.

24. The method of claim 22, wherein said pretreatment gas comprises nitrogen.

25. The method of claim 22, wherein said pretreatment gas comprises hydrogen and nitrogen.

26. The method of claim 15, wherein said treatment gas further comprises nitrogen.

27. The method of claim 22, wherein:
a) said pretreatment gas comprises an additional gas which is acceptable for said dairy product; and
b) said additional gas comprises an inert gas.

28. The method of claim 15, wherein:
a) said treatment gas comprises an additional gas which is acceptable for said dairy product; and
b) said additional gas comprises an inert gas.

29. The method of claim 27, wherein said additional gas comprises at least one member selected from the group consisting of:
a) argon;
b) helium;
c) oxygen;
d) carbon dioxide;
e) nitrous oxide; and
f) mixtures thereof.

30. The method of claim 28, wherein said additional gas comprises at least one member selected from the group consisting of:
a) argon;
b) helium;
c) oxygen;
d) carbon dioxide;
e) nitrous oxide; and
f) mixtures thereof.

31. The method of claim 29, wherein said additional gas comprises at least one member selected from the group consisting of:
a) carbon dioxide;
b) oxygen; and
c) mixtures thereof.

32. The method of claim 30, wherein said additional gas comprises at least one member selected from the group consisting of:
a) carbon dioxide;
b) oxygen; and
c) mixtures thereof.

33. The method of claim 27, wherein said pretreatment gas comprises a mixture of hydrogen and carbon dioxide.

34. The method of claim 28, wherein said treatment gas comprises a mixture of hydrogen and carbon dioxide.

35. A method which may be used for producing a fermented dairy product with improved organoleptic properties, said method comprising:
a) treating a milk mixture with a treatment gas comprising hydrogen, wherein:
1) said treated mixture has a desired redox potential value less than the redox potential value when said milk mixture is in equilibrium with air; and
2) said desired redox potential value is less than about +250 mV;
b) seeding said milk mixture with at least one strain of lactic acid bacteria; and
c) producing a dairy product with a modified property, wherein said property comprises at least one member selected from the group consisting of:
1) sensory properties of said dairy product;
2) the amount of flavoring compounds in said dairy product; and
3) the syneresis of said dairy product.

36. A method which may be used for producing a fermented dairy product with improved organoleptic properties, said method comprising:
a) treating a milk mixture with a treatment gas, wherein said treated mixture has a desired redox potential value less than the redox potential value when said milk mixture is in equilibrium with air; and
b) seeding said milk mixture indirectly with at least one strain of lactic acid bacteria, wherein at least one successive preculture is performed previously so as to constitute an inoculum which will serve to seed said milk mixture; and
c) treating the growth medium of said preculture with a pretreatment gas, wherein:
1) said treating reduces the redox potential of said preculture; and
2) said pretreatment gas and said treatment gas each comprise at least one member selected from the group consisting of:
i) hydrogen;
ii) nitrogen;
iii) argon;
iv) helium;
v) oxygen;
vi) carbon dioxide;
vii) nitrous oxide; and
viii) mixtures thereof.
